(19) United States
(12) Patent Application Publication
(10) Pub. No.: US 2012/0092331 A1
(43) Pub. Date: Apr. 19, 2012

(54) LIQUID CRYSTAL DISPLAY DEVICE AND METHOD OF CONTROLLING LIQUID CRYSTAL DISPLAY DEVICE

(75) Inventors: Ryo Ogawa, Tokyo (JP); Yuji Nakahata, Tokyo (JP)

(73) Assignee: SONY CORPORATION, Tokyo (JP)

(21) Appl. No.: 13/249,397

(22) Filed: Sep. 30, 2011

(30) Foreign Application Priority Data
Oct. 13, 2010 (JP) P2010-230691

(51) Int. Cl. G09G 3/36; G06T 15/00

(52) U.S. Cl. 345/419; 345/89

(57) ABSTRACT

A liquid crystal display device includes a liquid crystal display panel; a backlight that irradiates the liquid crystal display panel from a back surface; an image signal processing portion that processes an image signal; a driving control portion that drives and controls the liquid crystal display panel based on the output of the image signal processing portion; and a backlight control portion that controls the lighting of the backlight based on the output of the image signal processing portion, wherein the image signal processing portion controls a dynamic-range of a grayscale of the image signal depending on a change in grayscale between a left eye image and a right eye image when alternately inputting the image signal of the left eye image and the right eye image.

### CROSS-REFERENCE TO RELATED APPLICATION

The present application claims priority from Japanese Patent Application No. JP 2010-230691 filed in the Japanese Patent Office on Oct. 13, 2010, the entire content of which is incorporated herein by reference.

### BACKGROUND

The present disclosure relates to a liquid crystal display device and a method of controlling the liquid crystal display device. Particularly, the present disclosure relates to a liquid crystal display device that alternately displays a left eye image signal and a right eye image signal to present a stereoscopic image having a parallax between left and right eyes, and a method of controlling the liquid crystal display device.

By displaying an image having the parallax between left and right eyes, it is possible to present a stereoscopic image that is seen by an observer in a three-dimensional manner. As one method of presenting the stereoscopic image, a method is adopted which causes an observer to wear glasses having a special optical characteristic to present an image with a parallax in both eyes.

For example, a time division stereoscopic image display system includes a combination of a display device that displays a plurality of different images by a time division, and shutter glasses that are worn by an observer of the image. The display device alternately displays the left eye image and the right eye image with parallax on a screen in a very short period. Meanwhile, the shutter glasses worn by the observer include a shutter mechanism constituted by a liquid crystal lens or the like in the left eye portion and the right eye portion. The shutter glasses are configured so that the left eye portion of the shutter glasses transmits light and the right eye portion shields light while the left eye image is displayed. Furthermore, the right eye portion of the shutter glasses transmits light and the left eye portion shields light while the right eye image is displayed (see, for example, Japanese Unexamined Patent Application Publication Nos. 9-138384, 2000-36969, and 2003-45343). That is, the shutter glasses select the image by the shutter mechanism in synchronization with the time division display of the left eye image and the right eye image by the display device and the display switch-over of the display device, whereby the stereoscopic image is presented to the observer.

The display device used in the stereoscopic image display is not limited to a particular method. For example, in addition to a CRT (Cathode Ray Tube) display of the related art, a plasma-display-panel (PDD), a liquid crystal display (LCD), and an electroluminescence (EL) panel can be used. Among them, the liquid crystal display has characteristics of high luminance and low power consumption. The liquid crystal display is generally an active matrix type in which a TFT (Thin Film Transistor) is disposed for each pixel. The TFT liquid crystal display drives each pixel by writing the image signal from a screen upper portion toward a lower portion for each scanning line, and performs the display by blocking or transmitting irradiation light from a backlight by each pixel.

When displaying the stereoscopic image, ideally, it is desirable that the left eye image and the right eye image be completely separated from each other. In the time division stereoscopic image display system that includes the display device which performs the time division display of the left eye image and the right eye image mentioned above, and the shutter glasses, for example, if a moving image property of the display device side is insufficient, the left eye image and the right eye image are not separated from each other, and crosstalk is generated. That is, when the left eye image leaks to the right eye or the right eye image leaks to the left eye, the image is seen doubly or triply and becomes uglier, whereby the image is not stereoscopically seen by the observer, and an eye strain is caused. The crosstalk can be defined as a ratio of brightness when closing the shutter to brightness when opening the shutter during image observation.

Particularly, when a liquid crystal display is used in the stereoscopic image display, since a response, or transition between white (maximum luminance) and black (minimum luminance) is slow, there is a problem in that the crosstalk is easily generated.

For example, in a stereoscopic image display device such as a CRT or a liquid crystal, an image signal processor is presented in which a luminance level of the image signal before 1 field (or 1 frame) is reversed, and the level is lowered at a damping factor depending on the ratio of the brightness of the afterimage of the image, thereby forming the correction signal for removing the afterimage of the image (see, for example, Japanese Unexamined Patent Application Publication No. 7-38925).

Furthermore, there is a presentation of a method of suppressing the occurrence of crosstalk by raising the driving frequency of the liquid crystal display panel to display (write) the frames of left and right eye images on the liquid crystal display panel twice (see, for example, Japanese Unexamined Patent Application Publication No. 2010-210712), or a method of suppressing the occurrence of crosstalk by jointly using a method of synchronizing the opening and closing of the shutter with the backlight 136 (see, for example, Japanese Unexamined Patent Application Publication No. 2010-21731).

Furthermore, an image display device is presented which temporarily strengthens a light emission intensity of a light source as compared to a two dimensional image display time when intermittently lighting an illumination means so that the crosstalk of the left eye image and the right eye image is not generated, and prevents the crosstalk of the left eye image and the right eye image while ensuring the same level of brightness as the two-dimensional image display (see, for example, Japanese Unexamined Patent Application Publication No. 2010-49049).

### SUMMARY

It is desirable to provide an excellent liquid crystal display device and a method of controlling the liquid crystal display device that can alternately display the left eye image signal and the right eye image signal and can present a stereoscopic image of high quality while preventing the crosstalk between images.

According to a first embodiment of the present disclosure, there is provided a liquid crystal display device which includes a liquid crystal display panel; a backlight that irradiates the liquid crystal display panel from a back surface; an image signal processing portion that processes the image signal; a driving control portion that drives and controls the liquid crystal display panel based on the output of the image signal processing portion; and a backlight control portion that controls the lighting of the backlight based on the output of the image signal processing portion, wherein the image signal processing portion controls a dynamic-range of the grayscale of the image signal depending on a change in grayscale between the left eye image and the right eye image when alternately inputting the image signal of the left eye image and the right eye image.

According to a second embodiment of the present disclosure, the image signal processing portion of the liquid crystal display device described in the first embodiment may be configured so as to narrow the dynamic-range of the grayscale of the image signal when the grayscale of the left eye image is lower than a threshold value G_{down} of a low grayscale side and the grayscale of the right eye image is higher than a threshold value Gᵤₚ of a high grayscale side, or when the grayscale of the left eye image is higher than the threshold value Gᵤₚ of the high grayscale side and the grayscale of the right eye image is lower than the threshold value G_{down} of the low grayscale side.

According to a third embodiment of the present disclosure, the backlight control portion of the liquid crystal display device described in the first embodiment may be configured so as to partially drive the backlight depending on the dynamic-range of the grayscale of the image signal.

According to a fourth embodiment of the present disclosure, the backlight control portion of the liquid crystal display device described in the first embodiment may be configured so as to lower a quantity of light of the backlight according to the image signal processing portion raising the downside of the dynamic-range of the grayscale of the image signal and so as to raise the quantity of light of the backlight according to the image signal processing portion lowering the upside of the dynamic-range of the grayscale of the image signal.

According to a fifth embodiment of the present disclosure, the image signal processing portion of the liquid crystal display device described in the first embodiment may be configured so as to detect an amount of parallax between the left eye image and the right eye image, thereby narrowing the dynamic-range of the grayscale of the image signal depending on the amount of parallax.

Furthermore, according to a sixth embodiment of the present disclosure, there is provided a method of controlling the liquid crystal display device including: alternately inputting image signals of a left eye image and a right eye image; detecting a change in grayscales between the input left eye image and the input right eye image; and controlling a dynamic-range of the grayscale of the image signal depending on change in grayscales between the left eye image and the right eye image.

According to the embodiment of the present disclosure, it is possible to provide an excellent liquid crystal display device and a method of controlling the liquid crystal display device that can alternately display the left eye image signal and the right eye image signal and present the stereoscopic image having high quality, while preventing crosstalk between the images.

According to the embodiment of the present disclosure, it is possible to provide an excellent liquid crystal display device and a method of controlling the liquid crystal display device that can apply an over-drive technology to a combination of the whole changes in grayscale between the left and right eye images and can reduce the crosstalk, by adaptively narrowing the dynamic-range of the grayscale used in the liquid crystal display panel when a difference of the grayscale between the consecutive left and right eye images is increased.

According to the third and fourth embodiments of the present disclosure, since the backlight is partially driven depending on the dynamic-range of the grayscale of the image signal, the crosstalk can be significantly improved while maintaining the contrast.

According to the fifth embodiment of the present disclosure, since the dynamic-range of the grayscale of the image signal is narrowed depending on the amount of parallax between the left eye image and the right eye image, a further improvement in crosstalk is expected.

Further characteristics or advantages of the present disclosure will be apparent from the detailed description based on the embodiments of the present disclosure or the accompanying drawings.

### BRIEF DESCRIPTION OF THE DRAWINGS

FIG. 1 is a diagram that schematically shows a configuration of a stereoscopic image display system to which an embodiment of the present disclosure can be applied;

FIG. 2 is a diagram that shows a control operation of shutter glasses synchronized to a display period of a left eye image of the image display device;

FIG. 3 is a diagram that shows a control operation of shutter glasses synchronized to a display period of a right eye image of the image display device;

FIGS. 4A to 4C are diagrams that show writing the image of the liquid crystal display panel two times and opening and closing timings of left and right shutters of the shutter glasses;

FIG. 5 is a diagram that shows a response waveform of the liquid crystal display panel when alternately displaying black (minimum luminance) and white (maximum luminance) by the left eye image and the right eye image;

FIG. 6A is a diagram that shows an aspect of separating the left and right eye images by the shutter glasses with respect to the stereoscopic image having the response property as shown in FIG. 5;

FIG. 6B is a diagram (an enlarged view of a low contrast portion of a period when the left eye shutter is opened) that shows an aspect of separating the left and right eye images by the shutter glasses with respect to the stereoscopic image having the response property as shown in FIG. 5;

FIG. 7 is a diagram that shows a response waveform of the liquid crystal display panel upon narrowing a grayscale dynamic-range to 16 to 240 grayscales when the left eye image and the right eye image to be input are 0-0-255-255;

FIG. 8A is a diagram that shows an aspect of separating the left and right eye images by the shutter glasses with respect to the stereoscopic image having the response property as shown in FIG. 7;

FIG. 8B is a diagram (an enlarged view of a low contrast portion of a period when the left eye shutter is opened) that shows an aspect of separating the left and right eye images by the shutter glasses with respect to the stereoscopic image having the response property as shown in FIG. 7; and

FIG. 9 is a flow chart that shows a processing sequence for applying and controlling the dynamic-range of the grayscale of the liquid crystal display panel to the left and right eye image signal processing portion.

### DETAILED DESCRIPTION OF EMBODIMENTS

Hereinafter, an embodiment of the present disclosure will be specifically described with reference to the drawings.

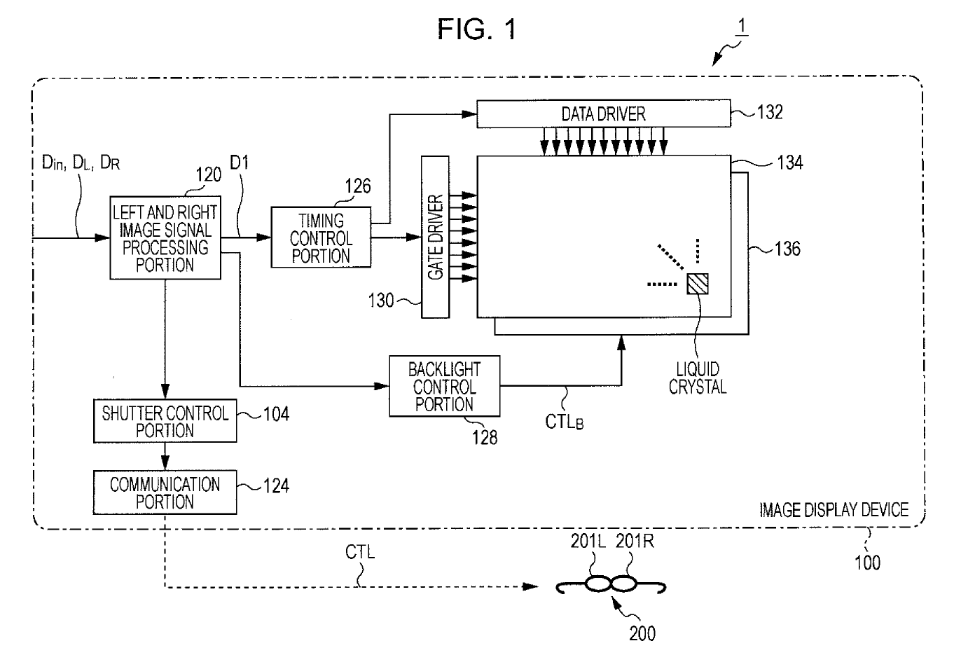

FIG. 1 schematically shows a configuration of a stereoscopic image display system 1 to which the present disclosure can be applied. The shown stereoscopic image display system 1 includes an image display device 100 which alternately displays a left eye image L and a right eye image R on a screen in a very short period, and shutter glasses 200 for enjoying a stereoscopic image. An observer uses the shutter glasses 200 while wearing them on his or her head.

The image display device 100 displaying the stereoscopic image is not limited to a particular method. However, in the present embodiment, the image display device 100 is referred to as a liquid crystal display. The liquid crystal display has the advantages of high luminance and low power consumption, but has also a disadvantage in that the response, or transition between white (maximum luminance) and black (minimum luminance) is slow.

The image display device 100 includes a left and right eye image signal processing portion 120, a shutter control portion 122, a communication portion 124, a timing control portion 126, a backlight control portion 128, a gate driver 130, a data driver 132, and a liquid crystal display panel 134.

The liquid crystal display panel 134 includes a liquid crystal layer, transparent electrodes facing the liquid crystal layer with the same interposed therebetween, a color filter, and the like (none of which are shown). Furthermore, a backlight (a surface light source) 136 is disposed behind the liquid crystal display panel 134. The backlight 136 includes an LED (Light Emitting Diode) or the like having a satisfactory afterglow property.

An input signal Dᵢₙ including left and right eye image signals D_{L} and D_{R} for displaying the left eye image L and the right eye image R, respectively, is input to the left and right eye image signal processing portion 120. The left and right eye image signal processing portion 120 alternately outputs the left and right eye image signals D_{L} and D_{R} for alternately displaying the left eye image L and the right eye image R on the liquid crystal display panel 134. Furthermore, based on the input left and right eye image signals D_{L} and D_{R}, in order to perform the writing twice as described below, the left and right eye image signal processing portion 120 performs the conversions of each of the left eye image signal D_{L} and the right eye image signal D_{R} so that the same signal is continued over the consecutive 2 frame periods.

The left eye image signal D_{L} and the right eye image signal D_{R} converted by the left and right eye image signal processing portion 120 are input to the timing control portion 126. The timing control portion 126 converts the input left eye image signal D_{L} and the right eye image signal D_{R} into singles to be input to the liquid crystal display panel 134, thereby creating a pulse signal that is used in the operation of the gate driver 130 and the data driver 132.

The pulse signal to be converted by the timing control portion 126 is input to the gate driver 130 and the data driver 132, respectively. The gate driver 130 and the data driver 132 receive the pulse signal created by the timing control portion 126, and cause the respective pixels of the liquid crystal display panel 134 to emit light based on the input signal. As a result, the image is displayed on the liquid crystal display panel 134.

Furthermore, the left and right eye image signal processing portion 120 sends the timing signal indicating the timing of the switch-over of the left eye image signal D_{L} and the right eye image signal D_{R} converted so as to be continued twice to the shutter control portion 122 and the backlight control portion 128.

The backlight control portion 128 outputs a control signal CLT_{B} for lighting the backlight 136 based on the timing signal to be sent from the left and right eye image signal processing portion 120. The backlight 136 performs the lighting based on the control signal CLT_{B} that is input from the backlight control portion 128. For example, the backlight 136 is a direct-under type backlight in which a light source is disposed below the liquid crystal display panel 134. In the present embodiment, the backlight control portion 128 is capable of switching the local-dimming of the backlight 136, that is, the brightness of the screen for each place.

The shutter control portion 122 creates an opening and closing control signal CTL, which controls the opening and closing operation of the left and right shutters 201L and 210R in synchronization with the switch-over timing of the right eye image signal, based on the timing signal to be sent from the left and right eye image signal processing portion 120, and outputs the opening and closing control signal CTL to the communication portion 124. The communication portion 124 transmits the opening and closing control signal CTL to the shutter glasses 200 in a wireless manner.

On the shutter glasses 200 side, when receiving the open control signal CTL wirelessly transmitted from the image display device 100, the signal is decoded to discriminate the opening and closing timings of the respective left and right shutters 201L and 201R, and the opening and closing operations of the respective left and right shutters 201L and 201R are controlled based on the discrimination result.

In addition, in many cases, an infrared ray communication is used as a communication unit between the image display device 100 and the shutter glasses 200, but a wireless network by a radio communication such as IEEE802.15.4 can be used. In a system configuration example shown in FIG. 1, the image display device 100 and the shutter glasses 200 perform the communication one-to-one. However, upon applying the wireless network, the communication portion 124 of the image display device 100 can be operated as an access point and can also concurrently accommodate a plurality of shutter glasses operated as terminal stations, respectively.

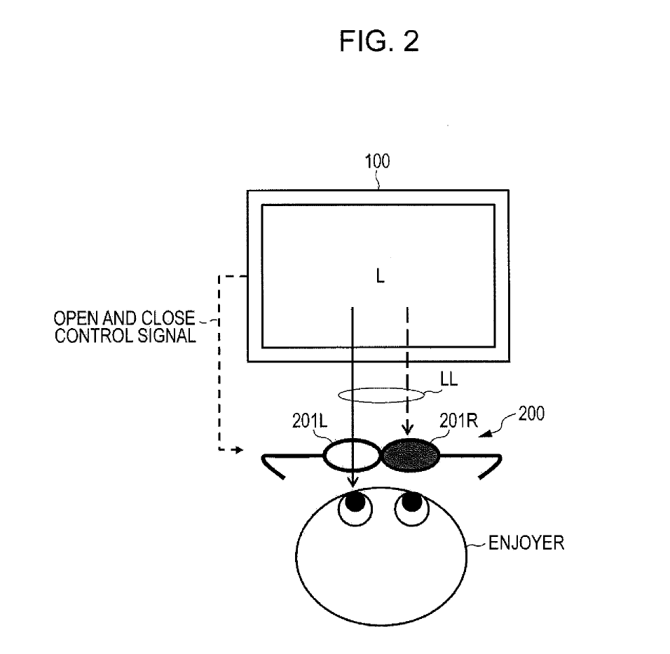

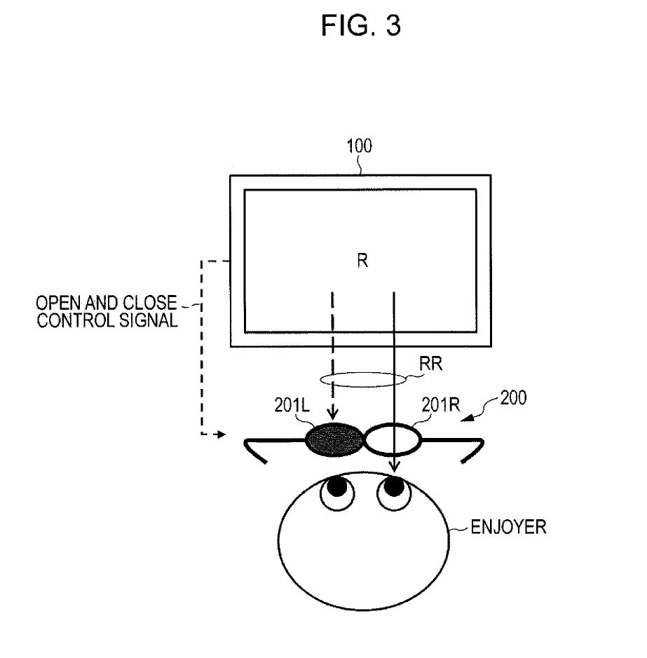

FIG. 2 shows a control operation of the shutter glasses 200 synchronized to the display period of the left eye image L of the image display device 100. As shown, during the display period of the left eye image L, by the opening and closing signal wirelessly transmitted from the image display device 100 side, the left eye shutter 201L enters the open state and the right eye shutter 201R enters the closed state, whereby a display light LL based on the left eye image L reaches only the left eye of the viewer. Furthermore, FIG. 3 shows the control operation of the shutter glasses 200 synchronized to the display period of the right eye image R. As is shown, during the display period of the right eye image R, by the opening and closing signal from the image display device 100, the right eye shutter 201R enters the open state and the left eye shutter 201L enters the close state, whereby a display light RR based on the right eye image R reaches only the right eye of a viewer.

For example, the image display device 100 alternately displays the left eye image L and the right eye image R for each field. On the shutter glasses 200 side, the left and right shutters 201L and 201R alternately perform the opening and closing operation in synchronization with the image switch-over of the image display device 100 for each field. The image displayed on the image display device 100 by the synthesis of the left eye image L and the right eye image R is recognized by the viewer in a three-dimensional manner. Of course, the image display device 100 can display a common two-dimensional image, and in this case, the switch-over between the left eye image L and the right eye image R is not performed.

In the present embodiment, in order to solve the occurrence of crosstalk, a lack of luminance or the like due to the lack of response speed in the liquid crystal, a method is adopted in which the driving frequency of the liquid crystal display panel 134 is increased and 1 frame of the left and right eye images is displayed (written) on the liquid crystal display panel 134 twice. When the left eye image L and the right eye image R are written over 2 frames, it can be expected that a desired luminance will be maintained during the second writing. A principle of writing the left and right eye images twice will be described as below.

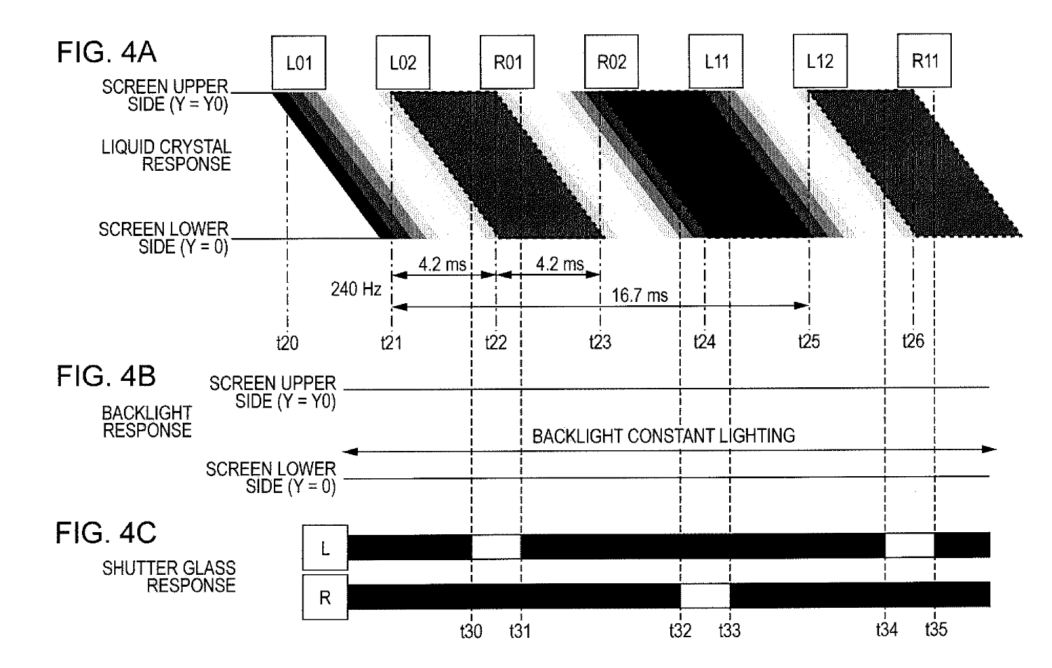

FIGS. 4A to 4C show the writing of the image of the liquid crystal display panel 134 two times and the opening and closing timing of the left and right shutters 201L and 201R of the shutter glasses 200. In FIGS. 4A to 4C, each of the left eye image L and the right eye image R is displayed at the driving frequency of 240 Hz. The period, during which the left eye image L and the right eye image R are displayed by the first writing, is 1/240 [Hz]=4.2 milliseconds.

FIG. 4A shows an aspect (a response of the liquid crystal) in which the luminance is changed together with the time in each position of a longitudinal direction leading from a screen upper side (Y=Y0) to a lower side (Y=0) of the liquid crystal display panel 134. Furthermore, FIG. 4B shows an aspect (a response of the backlight) in which the backlight 136 of the liquid crystal panel 134 emits light. In FIG. 4B, the backlight 136 is constantly lit. Furthermore, FIG. 4C shows the opening and closing timings of the left and right liquid crystal shutters 201L and 201R of the shutter glasses 200.

As shown in FIG. 4A, on the screen upper side (Y=Y0), the left eye image L01 is written during 4.2 milliseconds of the times from t20 to t21, and the left eye image L02 is written again during 4.2 milliseconds of the continuous times from t21 to t22. Herein, the left eye images L01 and L02, which are written from times t20 to t21 and from times t21 to t22, respectively, are basically the same image, but may be different from each other due to an adjustment such as over drive processing. Furthermore, a predetermined blank period may be provided between the firstly written left eye image L01 and the secondly written left eye image L02.

As mentioned above, after wiring the left eye image L02 twice, on the screen upper side (Y=Y0), the left eye image R01 is written during 4.2 milliseconds of the time from t22 to t23, and the left eye image R02 is written again during 4.2 milliseconds of the continuous time from t23 to t24. The right eye images R01 and R02, which are written between t22 and t23 and between t23 and t24, respectively, are basically the same image but may be different from each other due to an adjustment such as over drive processing. Furthermore, a predetermined blank period may be provided between the firstly written right eye image R01 and the secondly written right eye image R02 or between right eye image L02 and the right eye image R01.

Generally, since the response speed of the liquid crystal is relatively slow, when the first writing period is a short period, the respective pixels do not reach a desired luminance. When raising the driving frequency and shortening the first writing time to 4.2 milliseconds, a timing, during which both the screen upper side (Y=Y0) and the lower side (Y=0) reach a desired luminance, does not exist. On the contrary, as shown in FIG. 4A, when writing the left eye images L01 and L02 and the right eye images R01 and R02 twice, respectively, since a desired luminance is maintained during the second writing, it is possible to realize a state in which both the upper side (Y=Y0) of the screen and the lower side (Y=0) reach a desired luminance.

For example, at the point of time of t22, over all of the regions leading from the screen upper side (Y=Y0) to the lower side (Y=0), the luminance of the left eye image L reaches a desired level. Thus, as shown in FIG. 4C, by only opening the liquid crystal shutter 201L during predetermined periods t30 to t31 (for example, 2.1 milliseconds) around the time t22, the left eye image L02 including a desired luminance level reaches the left eye of the observer. Similarly, at the point of time of t24, since the luminance of the right eye image R02 reaches a desired level over all of the regions leading from the screen upper side (Y=Y0) and the lower side (Y=0), the liquid crystal shutter 200b may be opened only during periods t32 to t33 (for example, 2.1 milliseconds) around the time t24.

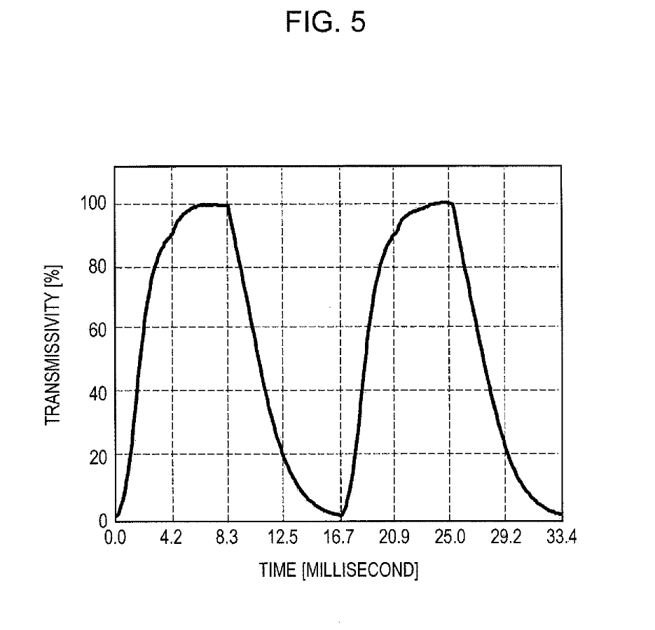

Herein, the grayscale numbers of each pixel of the liquid crystal display panel 134 are 8-bit, that is, have 256 grayscales from 0 to 255. FIG. 5 shows a response waveform of the liquid crystal panel 134 when displaying 0-0-255-255 by the left eye image L and the right eye image R, that is, alternating displaying black (the minimum luminance) as the left eye image and white (the maximum luminance) as the right eye image (when being written on the liquid crystal display panel 134 twice). A transverse axis of FIG. 5 indicates time, and a longitudinal axis indicates the brightness by the luminance ratio (contrast). In the longitudinal axis, 100 is the brightness of 255 grayscale and 0 is the brightness when the grayscale is 0.

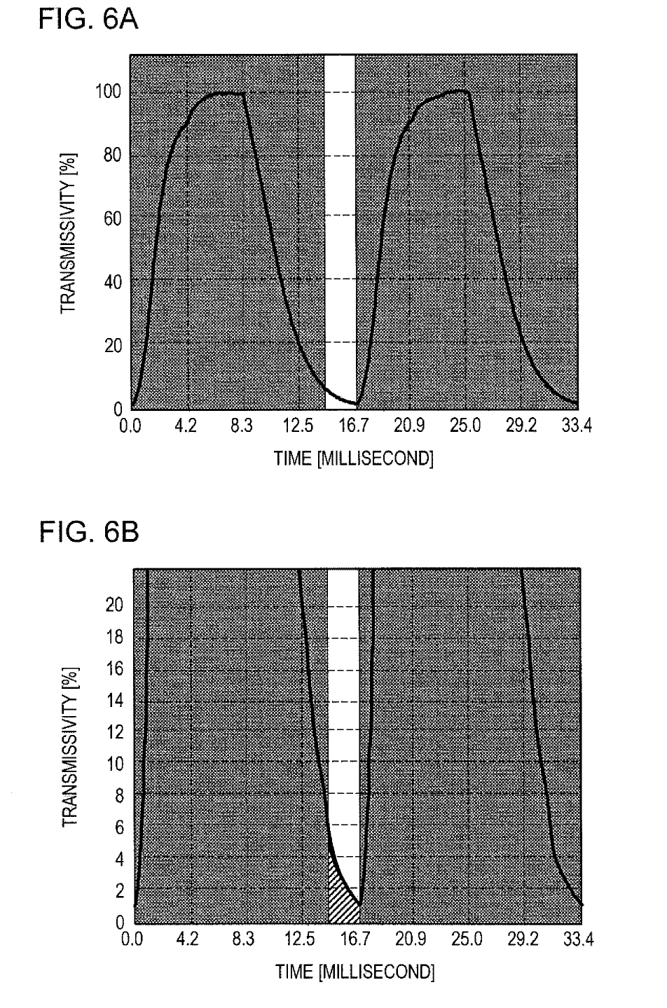

FIG. 6A shows an aspect in which the left and right eye images are separated by the shutter glasses 200 with respect to the stereoscopic image having the response property as shown in FIG. 5. In FIG. 6A, sections indicated by the shading are periods during which the left eye shutter 201L is closed, and other sections are periods during which the left eye shutter 201L is opened. Furthermore, FIG. 6B shows a portion of the low contrast in an expanded manner in the period during which one shutter is opened.

Naturally, the left eye image L has the 0 grayscale brightness, and 0 grayscale will be displayed on the left eye of the observer over the shutter glasses 200. However, since the response speed of the liquid crystal is insufficient, as shown in FIG. 6B, light leakage is generated in the period during which the left eye shutter 201L is opened, whereby the light leakage is recognized by the observer as crosstalk.

Driving the liquid crystal display panel 134 at 240 Hz and high speed is done to solve the occurrence of the crosstalk, the lack of luminance or the like due to the lack of the response speed of the liquid crystal as described with reference to FIGS. 4A to 4C. However, when the difference of grayscales between 0 and 255 and the left and right eye images becomes large, the crosstalk is generated in this manner. An over drive technology is disclosed which raises the response speed relative to the grayscale change from the middle grayscale to the middle grayscale. The over drive technology is to temporarily set the voltage applied to the liquid crystal molecules at a high level when the waveform rises, thereby reducing the time taken to change the orientation of the liquid crystal molecules, but is not applied to the grayscale change between white and black. It is considered that the response speed insufficiency relative to the grayscale change between white and black improves the response speed of the liquid crystal itself, but it is necessary to make the shell thickness of the liquid crystal display panel 134 thin, which causes a problem in that the yield deteriorates.

Thus, in the present embodiment, 0 to 255 grayscales of the liquid crystal display panel 134 of 8 bits are commonly used, and, when the grayscale change is great between the continuous left eye image L and the right eye image R (or when exceeding a predetermined threshold value), the dynamic-range of the grayscale of the image signal is narrowed, and an amount of crosstalk is reduced. For example, when the grayscale of the left eye image L02 is lower than the threshold value G_{down} of the low grayscale side and the grayscale of the right eye image R01 is higher than the threshold value Gᵤₚ of the high grayscale side, or when the grayscale of the left eye image L02 is higher than the threshold value Gᵤₚ of the high grayscale side and the grayscale of the right eye image R01 is lower than the threshold value G_{down} of the low grayscale side, the dynamic-range of the grayscales of the image signal is narrowed from 0 to 255 grayscales, for example to 16 to 240 grayscales.

Herein, changing the dynamic-range of the grayscale in the liquid crystal display panel 134 corresponds to changing the definitions of black and white. Originally, black is displayed by 0 grayscale and white is displayed by 255 grayscales. However, when narrowing the dynamic-range, black is displayed by 16 grayscales and white is displayed by 240 grayscales.

When narrowing the dynamic-range of the grayscale of the liquid crystal display panel 134 from 0 to 255 grayscales to, for example, 16 to 240 grayscales, since it is possible to apply the over drive technology to the combination of all the grayscale changes between the continuous left eye image L and the right eye image R, the crosstalk is improved.

The threshold value G_{down} of the low grayscale side and the threshold value Gᵤₚ of the high grayscale side are values relying on the response speed of the liquid crystal display panel 134 and are not unconditionally determined. In the examples shown in FIGS. 5 to 6B, it is considered that G_{down}=32 and Gᵤₚ=224 are reasonable values.

The adaptive control of the dynamic-range of such a grayscale is executed, for example, by the left and right eye image signal processing portion 120. When the left eye image L and the right eye image to be input to the left and right eye image signal processing portion 120 are 0-0-255-255 as shown in FIG. 5, that is, when the grayscale of the left eye image L02 to be input is lower than the threshold value G_{down} of the low grayscale side and the grayscale of the right eye image R01 is higher than the threshold value Gᵤₚ of the high grayscale side, the left and right eye image signal processing portion 120 narrows the dynamic-range of the grayscale and changes the definition of the grayscale level of black and white so as to display black by 16 grayscales and display white by 240 grayscales.

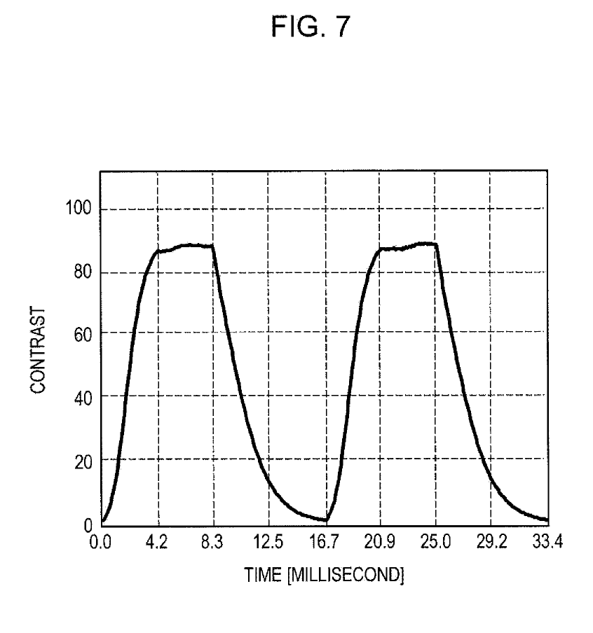

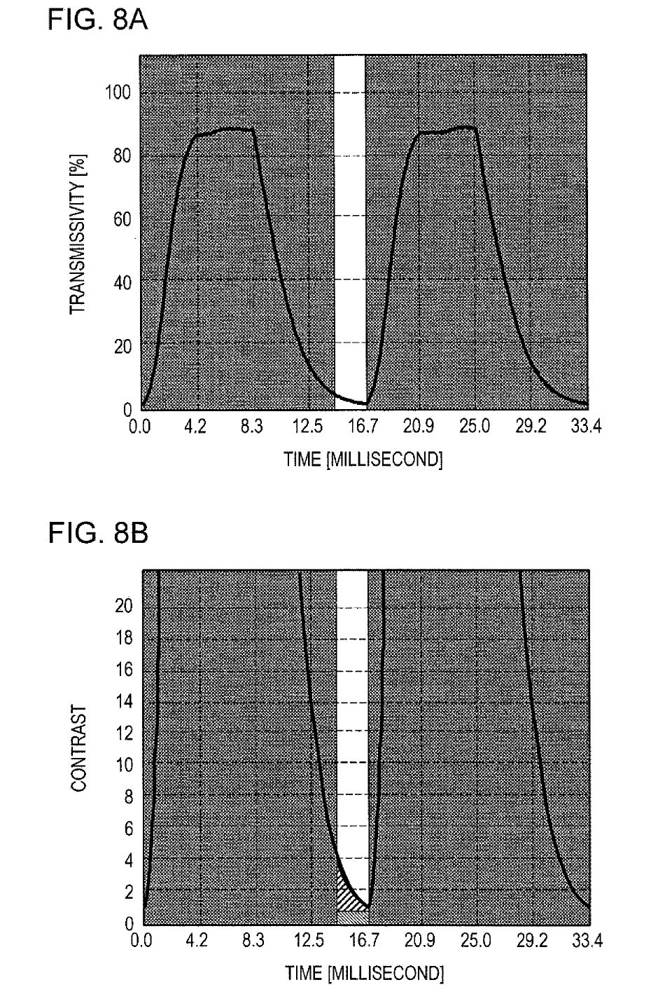

FIG. 7 shows a response waveform of the liquid crystal display panel 134 upon narrowing the dynamic-range of the grayscale to 16 to 240 grayscales when the left eye image L and the right eye image to be input are 0-0-255-255. The transverse axis of FIG. 7 indicates time, and the longitudinal axis thereof indicates the brightness by luminance ratio (contrast). FIG. 8A shows an aspect of separating the left and right eye images by the shutter glasses 200 with respect to the stereoscopic image having the response property as shown in FIG. 7. In FIG. 8A, sections indicated by the shading are periods during which the left eye shutter 201L is closed, and other sections are periods during which the left eye shutter 201L is opened. Furthermore, FIG. 8B shows a portion of the low contrast in an expanded manner in the period during which one shutter is opened.

Since the response speed of the liquid crystal is insufficient, as shown in FIG. 8B, the light leakage is generated in the period during which the left eye shutter 201L is opened. However, since the black and white level is redefined by the conversion of the dynamic-range and white is displayed by up to 16 grayscales during light leakage, the amount of crosstalk is reduced. Furthermore, by changing the definitions of the respective grayscale levels of black and white, the over drive technology can be applied, whereby the amount of crosstalk is reduced.

In addition, upon narrowing the dynamic-range of the gray scale when the grayscale change is great between the continuous left eye image L and the right eye image R, there is no need to concurrently change the upside (that is, the definition of the white level) of the dynamic-range and the downside (that is, the definition of the black level) of the dynamic range. For example, the grayscale (that is, the definition of the white level) of the upside of the dynamic range may be simply lowered, or the grayscale (that is, the definition of the black level) of the downside of the dynamic-range may be simply raised.

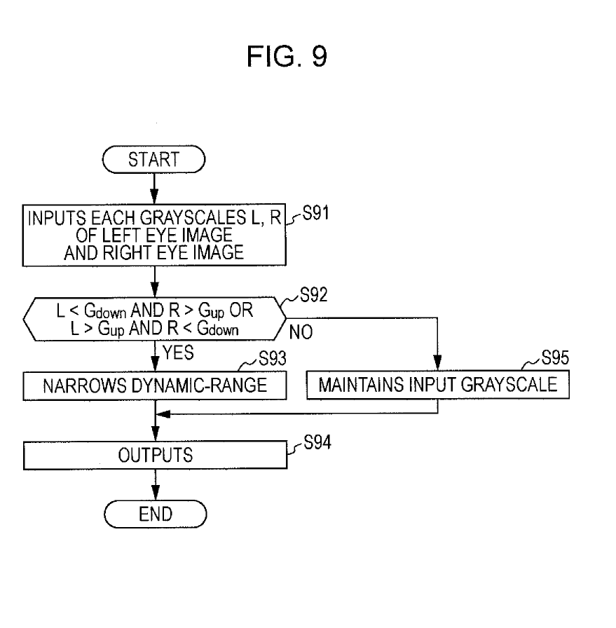

FIG. 9 shows a processing sequence for applying and controlling the dynamic-range of the grayscale of the liquid crystal display panel 134 in the left and right eye image signal processing portion 120 in the form of a flow chart.

When the respective grayscales L and R of the continuous left eye image and right eye image are input (step S91), the left and right eye image signal processing portion 120 determines whether the input grayscale L from the left eye image is lower than the threshold value G_{down} of the low grayscale side and the input grayscale R from the right eye image is higher than the threshold value Gᵤₚ of the high grayscale side, or whether the input grayscale L from the left eye image is higher than the threshold value Gᵤₚ of the high grayscale side and the input grayscale R from the right eye image is lower than the threshold value G_{down} of the low grayscale side (step S92).

Herein, when the input grayscale L from the left eye image and the input grayscale R from the right eye image are equal to or greater than the threshold value G_{down} of the low grayscale side and are equal to or less than the threshold value Gᵤₚ of the high grayscale side (No of step S92), the left and right eye image signal processing portion 120 maintains the input grayscales L and R as they are (step S95) and outputs the same (step S94).

Meanwhile, when the input grayscale L from the left eye image is lower than the threshold value G_{down} of the low grayscale side and the input grayscale R from the right eye image is higher than the threshold value Gᵤₚ of the high grayscale side, or when the input grayscale L from the left eye image is higher than the threshold value Gᵤₚ of the high grayscale side and the input grayscale R from the right eye image is lower than the threshold value G_{down} of the low grayscale side (Yes of step S92), the left and right eye image signal processing portion 120 narrows the dynamic-range of the grayscales of the image signal, maintains the same (step S93), and outputs the same (step S94).

As mentioned above, when the grayscale change is great between the continuous left eye image L and the right eye image R, by narrowing the dynamic-range of the grayscale of the image signal, the amount of crosstalk can be reduced. However, when simply narrowing the dynamic-range, there is a problem in that the grayscale of the minimum luminance becomes higher than the original, the grayscale of the maximum luminance becomes lower than the original, and thus, the contrast declines.

A method is considered in which the problem of decline in contrast due to the switch-over of the dynamic-range of the grayscale is solved by the use of the local-dimming of the backlight 136. Specifically, when raising the lower grayscale (that is, the definition of the black level) of the dynamic-range from 0 to 16, the backlight control portion 128 lowers the amount of light of the backlight 136, thereby maintaining the contrast. Furthermore, on the contrary, when lowering the upper grayscale (that is, the definition of the white level) of the dynamic-range from 255 to 240, the backlight control portion 128 raises the amount of light of the backlight 136, thereby maintaining the contrast.

Furthermore, the backlight control portion 128 may lower the amount of light of the backlight 136 in a place which comes to have a low grayscale within the screen or may raise the amount of light of the backlight 136 in a place which comes to have a high grayscale within the screen to switch over the brightness of the backlight 136 for each place within the screen, thereby maintaining the contrast.

As mentioned above, when the grayscale change is great between the continuous left eye image L and the right eye image R, the dynamic-range of the grayscale of the image signal is combined by narrowing the same, the amount of parallax between the left eye image and the right eye image, and the grayscale difference of the parallax portion are detected, and the dynamic-range is dynamically changed, whereby the amount of crosstalk can be reduced. Otherwise, when the grayscale change is great between the continuous left eye image L and the right eye image R, instead of narrowing the dynamic-range of the grayscale of the image signal, by detecting the amount of parallax of the left eye image and the right eye image and the grayscale difference of the parallax portion and dynamically changing the dynamic-range, the amount of crosstalk can be reduced.

When the continuous left eye image L and the right eye image R are input, the left and right eye image signal processing portion 120 detects the amount of parallax between the images and the grayscale difference of the parallax portion. Moreover, when the amount of parallax exceeds a predetermined value, the response speed of the liquid crystal is insufficient, which causes the crosstalk. Thus, the left and right eye image signal processing portion 120 narrows the dynamic-range of the grayscales of the image signal to improve the crosstalk.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device comprising:
a liquid crystal display panel;
a backlight that irradiates the liquid crystal display panel from a back surface;
an image signal processing portion that processes an image signal;
a driving control portion that drives and controls the liquid crystal display panel based on the output of the image signal processing portion; and
a backlight control portion that controls the lighting of the backlight based on the output of the image signal processing portion,
wherein the image signal processing portion controls a dynamic-range of a grayscale of the image signal depending on a change in grayscale between a left eye image and a right eye image when alternately inputting the image signal of the left eye image and the right eye image.

2. The liquid crystal display device according to claim 1,
wherein the image signal processing portion narrows the dynamic-range of the grayscale of the image signal when the grayscale of the left eye image is lower than a threshold value G_{down} of a low grayscale side and the grayscale of the right eye image is higher than a threshold value Gᵤₚ of a high grayscale side, or when the grayscale of the left eye image is higher than the threshold value Gᵤₚ of the high grayscale side and the grayscale of the right eye image is lower than the threshold value G_{down} of the low grayscale side.

3. The liquid crystal display device according to claim 1,
wherein the backlight control portion partially drives the backlight depending on the dynamic-range of the grayscale of the image signal.

4. The liquid crystal display device according to claim 1,
wherein the backlight control portion lowers a quantity of light of the backlight according to the image signal processing portion raising the downside of the dynamic-range of the grayscale of the image signal and raises the quantity of light of the backlight according to the image signal processing portion lowering the upside of the dynamic-range of the grayscale of the image signal.

5. The liquid crystal display device according to claim 1,
wherein the image signal processing portion detects an amount of parallax between the left eye image and the right eye image to narrow the dynamic-range of the grayscale of the image signal depending on the amount of parallax.

6. A method of controlling a liquid crystal display device comprising:
alternately inputting image signals of a left eye image and a right eye image;
detecting a change in grayscales between the input left eye image and the input right eye image; and
controlling a dynamic-range of the grayscale of the image signal depending on change in grayscales between the left eye image and the right eye image.
